(19) United States
(12) Patent Application Publication
(10) Pub. No.: US 2014/0335259 A1
(43) Pub. Date: Nov. 13, 2014

(54) METHODS FOR REDUCING MICROBIAL CONTAMINATION OF DRYBLENDED POWDERED NUTRITIONAL COMPOSITIONS

(71) Applicant: ABBOTT LABORATORIES, ABBOTT PARK, IL (US)

(72) Inventors: Mustafa Vurma, Dublin, OH (US); Wendy S. Fox, Hilliard, OH (US); Nurdan Kocaoglu-Vurma, Dublin, OH (US)

(73) Assignee: ABBOTT LABORATORIES, ABBOTT PARK, IL (US)

(21) Appl. No.: 14/368,519

(22) PCT Filed: Dec. 19, 2012
(86) PCT No.: PCT/US2012/070588

§ 371 Date: Jun. 25, 2014

Related U.S. Application Data
(60) Provisional application No. 61/581,458, filed on Dec. 29, 2011.

(51) Int. Cl. A23L 3/16; A23L 1/29; A23L 2/46; A23L 2/39

(52) U.S. Cl. CPC A23L 3/165; A23L 2/39; A23L 1/296; A23L 2/46; A23V 2002/00
USPC 426/590; 426/465

(57) ABSTRACT

Disclosed are methods of preparing dryblended powdered nutritional compositions including at least one dry ingredient that has undergone a microbial inactivation heat treatment sufficient to inactivate microbes present therein. The heat treatment comprises subjecting the dry ingredient to a temperature of greater than 48° C. to no greater than 60° C. for a period of from 2 days to 30 days and allows for incorporation of the dry ingredient into the dryblended powdered nutritional composition without risk of substantial microbial contamination of the composition, and further, without substantially altering the physical and functional properties of the dry ingredient.

### CROSS REFERENCE TO RELATED APPLICATIONS

The present invention hereby claims the benefit of the provisional patent application Ser. No. 61/581,458, filed Dec. 29, 2011, the disclosure of which is hereby incorporated by reference in its entirety.

### FIELD OF THE DISCLOSURE

The present disclosure relates to methods of inactivating microbes in dry ingredients, dryblended powdered nutritional compositions, and spray dried nutritional compositions. More particularly, the dry ingredients or compositions are heat treated at a temperature and for a period of time sufficient to inactivate microbes present therein without substantially altering the physical and functional properties of the dry ingredients and the resulting dryblended or spraydried powdered nutritional composition.

### BACKGROUND OF THE DISCLOSURE

Adult, pediatric, and infant manufactured nutritional compositions comprising a targeted selection of nutritional ingredients are well known and widely available, some of which may provide a sole source of nutrition, while others may provide a supplemental source. These nutritional compositions include nutritional powders that can be reconstituted with water or other aqueous liquid. These nutritional powders may be dryblended nutritional powders that include dry ingredients blended together or spray dried nutritional powders that may optionally include one or more dryblended components.

Powdered infant formulas are especially popular for providing nutrition early in life and their use continues to increase around the world. These powdered infant formulas are typically prepared by making at least two separate slurries that are first blended together. One slurry may be an aqueous-based slurry and one may be an oil-based slurry. After blending, the resulting mixture is generally heat-treated, standardized, heat-treated a second time, spray dried, agglomerated and packaged. With this manufacturing process, a substantial amount of energy is required to spray dry the composition and the drying process significantly increases manufacturing time. Some beneficial ingredients in the formulas are potentially heat sensitive and may possibly partially thermally degrade under some of the conditions of heat treatments and spray drying. Other beneficial components may potentially be highly reactive and should be handled with care during manufacturing to ensure that they do not react, and subsequently degrade, with other nutritional ingredients present in the composition. Accordingly, some of these sensitive ingredients and/or reactive ingredients have been added to base nutritional powders that have been conventionally prepared using a spray drying process by dryblending or drymixing the ingredient into the base powder. With dryblending or drymixing, the ingredient is introduced into a base powder, which is generally a spray dried base powder, after the powder exits the spray drier. The ingredient is mixed into the base powder to create a substantially homogeneous end dryblended composition.

Although dryblending or drymixing has been used to introduce some heat sensitive or highly reactive nutritional components into a conventionally prepared base powder, maintaining an acceptable level of microorganisms has been a general concern for dryblending applications as an additional ingredient, that has not generally been subjected to the heat treatments for sterilization, and is being added to a powder previously subjected to a heat treatment. To date, the use of dryblending has been generally somewhat limited to certain components, such as vitamins and minerals, which are less susceptible to microbial contamination, including contamination by Enterobacteriaceae, including Cronobacter sakazakii, such that the risk of contamination of the end dryblended composition is reduced. Many components, including proteins, have traditionally simply had too high of a risk of potential microbial contamination to allow for safe dryblending or drymixing.

Accordingly, there is a continuing need in the art for methods of preparing dryblended powdered nutritional compositions including dry ingredients having a reduced risk of microbial contamination and an acceptable level of microorganisms. Additionally, it would be advantageous if microbes in the dry ingredients could be inactivated using conditions that will not compromise the physical quality and function of the ingredients so as not to deteriorate the final nutritional composition. It would also be advantageous if the dryblended ingredient could be treated for microbial contamination prior to or after introduction into the commercial base powder.

### SUMMARY OF THE DISCLOSURE

The present disclosure is directed to methods of reducing the microbial contamination of dry ingredients for use in dryblended compositions, and to methods of reducing the microbial contamination of dryblended compositions. The methods described herein utilize heat treatment methods that are capable of significantly reducing the microbial content of a single dry ingredient or dryblended composition without substantially altering the nutritional or physical quality of the ingredient or composition. The heat treatment methods are easy to use, safe and provide a dry ingredient or dryblended composition with a high degree of microbial inactivation.

One embodiment of the present disclosure is directed to a method of inactivating microbes in a dry ingredient, the method comprising subjecting the dry ingredient to a heat treatment at a temperature of greater than 48° C. to no greater than 60° C. for a period of from 2 days to about 30 days.

Another embodiment of the present disclosure is directed to a method of preparing a dryblended powdered nutritional composition, the dryblended powdered nutritional composition comprising at least one dry ingredient. The method comprises subjecting the dry ingredient to a heat treatment at a temperature of greater than 48° C. to no greater than 60° C. for a period of from 2 days to about 30 days; and dryblending the heat treated dry ingredient with a base powder to form the dryblended powdered nutritional composition.

Another embodiment of the present disclosure is directed to a method of preparing a dryblended powdered nutritional composition, the dryblended powdered nutritional composition comprising at least one dry ingredient. The method comprises dryblending the dry ingredient with a base powder to form the dryblended powdered nutritional composition; and subjecting the dryblended powdered nutritional composition to a heat treatment at a temperature of greater than 48° C. to no greater than 60° C. for a period of from 2 days to about 30 days.

Another embodiment of the present disclosure is directed to a method of preparing a powdered nutritional composition. The method comprises subjecting the powdered nutritional composition to a heat treatment at a temperature of greater than 48° C. to no greater than 60° C. for a period of from 2 days to about 30 days.

It has been unexpectedly found that microbes present in dry ingredients can be inactivated under relatively low temperatures when held at the low temperatures for a relatively long time period. By treating dry ingredients under these conditions, dryblended powdered nutritional compositions can be prepared with reduced risk of microbial contamination without compromising the physical and functional properties of the dry ingredient. That is, the dry ingredients can be treated without reducing or eliminating the nutritional benefits provided from such ingredients. This is a significant finding as conventional heat treatments have invariably lead to at least some change in the physical and/or functional properties of the treated ingredient.

### DETAILED DESCRIPTION OF THE DISCLOSURE

The methods of the present disclosure provide for dry ingredients and dryblended powdered nutritional compositions including the dry ingredients that have been heat treated under conditions sufficient to inactivate microbes without altering, or substantially altering, the physical and functional properties of the dry ingredient and dryblended powdered composition. The methods described in the present disclosure address and overcome the longstanding problem of microbial contamination in dry ingredients that can be used in dryblended nutritional compositions, as well as the resulting dryblended compositions themselves. Although prior methods of reducing the microbial load in dry ingredients have been available, these methods have had the tendency to potentially change the functional, physical, and/or nutritional quality of the dry ingredient and resulting dryblended composition. Additionally, such methods have not been particularly convenient to utilize during the manufacturing process.

The methods described herein offer a new alternative means for reducing the microbial load of dry ingredients and dryblended nutritional compositions by subjecting the ingredient and/or composition to a new low temperature heat treatment over a longer period of time than conventionally used, such that the dry ingredient and resulting dryblended composition are not substantially altered functionally, physically or nutritionally and have a reduced microbial content. Conveniently, the methods of the present disclosure can easily be utilized with dry ingredients in original packaging as received so that the dry ingredient can be treated as received just prior to dryblending. The low temperature heat treatment methods described herein advantageously do not require any special handling or special processing steps prior to heat treatment for microbial load reduction. As such, the present disclosure provides for an easy and cost effective means of reducing the microbial loads of dry ingredients and/or dryblended compositions that may be carried out in a number of commercial locations, including the warehouse where the ingredients are stored prior to use or where the dryblended compositions are stored after manufacture.

These and other optional elements or limitations of the methods and nutritional compositions prepared by the methods of the present disclosure are described in detail hereafter.

The term “dryblended powdered nutritional composition” as used herein, unless otherwise specified, refers to nutritional compositions prepared by mixing at least one dry component or ingredient to form a nutritional base powder or, by the addition of a dry, powdered or granulated component or ingredient to a base powder to form the powdered nutritional composition. The powdered nutritional compositions are reconstitutable with an aqueous liquid and are suitable for oral administration to a human. It should be understood that the nutritional base powder may be prepared using solely dryblending processes or other conventional wet processes known in the art that utilized heat steps and drying steps.

The terms “dry component” or “dry ingredient” as used herein, unless otherwise specified, are used interchangeably to refer to an ingredient having up to 7% by weight moisture (i.e., water), including less than 6.5% by weight moisture, including less than 6.0% by weight moisture, including less than 5.5% by weight moisture, including less than 5.0% by weight moisture, including less than 4.5% by weight moisture, including less than 4% by weight moisture, including less than 3.5% by weight moisture, including less than 3% by weight moisture, including less than 2.5% by weight moisture, including less than 2% by weight moisture, including less than 1.5% by weight moisture, including less than 1% by weight moisture, and including less than 0.5% by weight moisture, and including 0% by weight moisture.

The tetin “infant formula” as used herein, unless otherwise specified, refers to solid infant formulas and toddler formulas, wherein infant formulas are intended for infants up to about 1 year of age and toddler formulas are intended for children from about 1 year of age to about 10 years of age.

The term “preterm infant formula” as used herein, unless otherwise specified, refers to solid nutritional compositions suitable for consumption by a preterm infant. The term “preterm infant” as used herein, refers to a person born prior to 36 weeks of gestation.

The terms “adult formula” and “adult nutritional product” as used herein, are used interchangeably to refer to formulas for generally maintaining or improving the health of an adult, and includes those formulas designed for adults who have, are susceptible to, or are at risk of specific diseases and conditions.

The terms “fat” and “oil” as used herein, unless otherwise specified, are used interchangeably to refer to lipid materials derived or processed from plants or animals.

The terms “inactivate” or “inactivating” as used herein, refer to altering microbes such to put the microbes in a non-viable state; that is, a state in which the microbial cells are non-culturable and are metabolically inactive. The methods of the present disclosure inactivate at least 90% of the microbes present in the dryblended ingredients, including at least 92% of the microbes present in the dryblended ingredients, including at least 95% of the microbes present in the dryblended ingredients, including at least 97% of the microbes present in the dryblended ingredients, including at least 98% of the microbes present in the dryblended ingredients, including at least 99% of the microbes present in the dryblended ingredients, and also including at least 99.999% of the microbes in the dryblended ingredients. Stated another way, the methods of the present disclosure provide at least a 1 log, or even a 2 log, or even a 3 log, or even a 4 log, or even a 5 log or more reduction to complete inactivation.

The terms “microbe” or “microorganism” as used herein, are used herein interchangeably to refer to organisms having a single cell, cell clusters or no cell at all, and include, for example, bacteria, fungi, archaea, and protists, which can cause disease.

All percentages, parts and ratios as used herein, are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The various embodiments of the dryblended powdered nutritional compositions prepared using the methods of the present disclosure may also be substantially free of any optional or selected essential ingredient or feature described herein, provided that the remaining dryblended powdered nutritional composition still contains all of the required ingredients or features as described herein. In this context, and unless otherwise specified, the term “substantially free” means that the selected powdered nutritional compositions contain less than a functional amount of the optional ingredient, typically less than 0.1% by weight, and also including zero percent by weight of such optional or selected essential ingredient.

The dryblended powdered nutritional compositions and corresponding manufacturing methods of the present disclosure can comprise, consist of, or consist essentially of the essential elements of the disclosure as described herein, as well as any additional or optional element described herein or otherwise useful in powdered nutritional composition applications.

### Methods of Manufacture of Dryblended Nutritional Composition

The dryblended powdered nutritional compositions prepared in accordance with the present disclosure include one or more dry ingredients that are subjected to a low temperature heat treatment prior to incorporation into the dryblended composition to inactivate microbes, thereby reducing the risk of microbial contamination of the dryblended powdered nutritional compositions. Alternatively, the dryblended powdered nutritional compositions can be prepared including one or more dryblended components and the entire dryblended powdered nutritional composition can be heat treated to inactivate microbes. As such, the methods of the present disclosure are equally applicable to reducing the microbial load of a single dry ingredient for use in a dryblending process and to reducing the microbial load on an entire dryblended composition that may include one, two, three or more dry ingredients that may or may not have been subjected to a separate process for microbial load reduction.

The heat treatment to reduce the microbial load on the dry ingredient and/or dryblended composition is typically conducted at a temperature sufficient to inactivate a wide variety of microbes yet is not sufficiently harsh to lead to a change in the physical and/or functional and/or nutritional properties of the treated ingredients or composition. In order to meet these requirements, the heat treatment is conducted at a temperature of greater than 48° C., but no greater than 60° C. This temperature range has been found to be sufficient to inactivate microbes without substantially negatively impacting the dry ingredient or dryblended composition. Other suitable temperatures for the heat treatment include from about 50° C. to 60° C., from about 50° C. to about 58° C., and including from about 50° C. to about 55° C., and including specifically, 49° C., 50° C., 51° C., 52° C., 53° C., 54° C., 55° C., 56° C., 57° C., 58° C., 59° C., and 60° C. The heat treatment is conducted for a period of at least 2 days, including from 2 days to about 30 days, including from 2 days to about 28 days, including from 2 days to about 25 days, including from 2 days to about 20 days, including from 2 days to about 18 days, including from 2 days to about 16 days, including from 2 days to about 14 days, including from 2 days to about 12 days, including from 2 days to about 10 days, including from 2 days to about 9 days, including from 2 days to about 8 days, including from 2 days to about 6 days, and including from 2 days to about 4 days, including 3 days.

In one embodiment, the dry ingredient is subjected to the heat treatment prior to being dryblended into a nutritional base powder. In an alternative embodiment, the dry ingredient is first dryblended into the base powder to form a dryblended powdered nutritional composition, and then the composition is subjected to the heat treatment. The dry ingredient or the composition to be heat treated, may be packaged and the package placed in the heat treatment conditions described herein. Alternatively, the heat treatment may occur prior to packaging. For example, the dryblended powdered nutritional composition including the dry ingredient may be packaged and sealed in single or multi-use containers and then stored in a storage facility or other housing that has been heated to a temperature of from greater than 48° C. to no greater than 60° C. for a period of from 2 days to about 30 days to inactivate the microbes in the dry ingredient. In one specific embodiment, an individual ingredient for dryblending is subjected to the heat treatment in the package in which it is shipped; that is, the ingredient need not be removed from its packaging prior to the heat treatment to obtain the benefits described herein.

After heat treatment, the dry ingredient and/or the dryblended powdered nutritional compositions prepared using the methods of the present disclosure may be stored under ambient conditions for up to about 36 months or longer, more typically from about 12 to about 24 months. For multi-use containers, these packages can be opened and then covered for repeated use by the ultimate user, provided that the covered package is then stored under ambient conditions (e.g., to avoid high temperatures) and the contents used within about one month or so.

The nutritional base powders (into which one or more of the dry ingredients are dryblended) of the present disclosure may be prepared by any known or otherwise effective technique suitable for making and formulating a nutritional base powder or similar other formula, variations of which may depend upon variables such as the ingredient combination, packaging and container selection, and so forth, for the desired nutritional base powder. Such techniques and variations for any given formula are easily determined and applied by one of ordinary skill in the nutritional base powder or manufacturing arts.

The nutritional base powders of the present disclosure, including the exemplified formulas described hereinafter, can therefore be prepared by any of a variety of known or otherwise effective composition or manufacturing methods. These methods most typically involve the initial formation of an aqueous slurry containing carbohydrates, proteins, lipids, stabilizers or other formulation aids, vitamins, minerals, or combinations thereof. The slurry is emulsified, pasteurized, homogenized, and cooled. Various other solutions, mixtures, or other materials may be added to the resulting emulsion before, during, or after further processing. This emulsion can then be further diluted, heat-treated, and subsequently dried via spray-drying or the like to produce a nutritional base powder. Other suitable methods of producing a nutritional base powder are described, for example, in U.S. Pat. No. 6,365,218 (Borschel, et al.), U.S. Pat. No. 6,589,576 (Borschel, et al.), U.S. Pat. No. 6,306,908 (Carlson, et al.), U.S. Patent Application No. 20030118703 (Nguyen, et al.), all of which are hereby incorporated by reference to the extent they are consistent herewith.

Once the nutritional base powder has been produced, the dry ingredient as described above is dryblended into the nutritional base powder to produce the dryblended powdered nutritional composition. The dry ingredient is introduced into the nutritional base powder and thoroughly mixed into the nutritional base powder using suitable conventional mixing equipment to produce a substantially homogeneous nutritional powder.

### Methods of Use

The methods of the present disclosure provide for the dryblending of nutritional dry ingredients, including, for example, carbohydrates, proteins, fats, vitamins, minerals, and the like, into nutritional base powders to prepare dryblended nutritional powders that have a reduced microbial contamination. Particularly, by subjecting the dry ingredients to the heat treatment described herein (or by subjecting an entire dryblended composition to the heat treatments described herein), the microbes of the dry ingredient (or composition) are inactivated so as to prevent microbial growth in the resulting dryblended powdered nutritional composition. The heat treatment inactivates at least 90% of the microbes present in the dryblended ingredients, including at least 98% of the microbes, including at least 99%, and also including at least 99.999% of the microbes in the dryblended ingredients, as further discussed in detail below.

In one particular embodiment, the present disclosure provides a method for the inactivation of microbes in a dry ingredient for use in a dryblended powdered nutritional composition. In this particular embodiment, the method includes subjecting the dry ingredient, which may be in the original packaging as received from the supplier, to a heat treatment at a temperature of greater than 48° C. to no greater than 60° C. for a period of from 2 days to about 30 days to inactivate microbes located in the dry ingredient. Thereafter, the dry ingredient may be dryblended into a nutritional powder with a reduced risk of microbial contamination.

Further, in another particular embodiment, the present disclosure provides a method for the preparation of a dryblended powdered nutritional composition that has a reduced microbial load. The dryblended powdered nutritional composition comprises at least one dry ingredient, and the method includes subjecting the dry ingredient to a heat treatment at a temperature of greater than 48° C. to no greater than 60° C. for a period of from 2 days to about 30 days to inactivate microbes located in the dry ingredient. After this inactivation, the heat treated dry ingredient is dryblended with a base powder to form the dryblended powdered nutritional composition. The base powder may be a spray dried base powder, or a dryblended base powder, for example.

In one other particular embodiment, the present disclosure provides for a method of preparing a dryblended powdered nutritional composition. In this method, the dryblended powdered nutritional composition includes at least one dry ingredient. This method includes dryblending the dry ingredient with a base powder, which could be a spray dried base powder or a dryblended base powder, to form the dryblended powdered nutritional composition that is then subjected to a heat treatment at a temperature of greater than 48° C. to no greater than 60° C. for a period of from 2 days to about 30 days. The heat treatment reduces the microbial load of the dryblended powdered nutritional composition.

Further, the heat treatment conditions used in the methods of the present disclosure promote microbial inactivation while not altering or substantially altering the physical and/or functional and/or nutritional properties of the dry ingredient or dryblended composition; that is, the heat treatment conditions utilized will not alter or substantially alter the physical characteristics or functional or nutritional properties of the resulting dryblended nutritional compositions. This is significant as the methods of inactivation of the present disclosure can be utilized without changing or substantially changing the properties of the end product. This is unlike heat treatments conventionally used for sterilization processes as these treatments can impart some changes to the final compositions. Thus, the dry ingredient can be incorporated into the dryblended powdered nutritional composition to provide similar functional benefits to the composition as conventional dry ingredients; however, the introduction of the dry ingredient into the composition will not increase the risk of composition contamination.

Although the embodiments of the present disclosure are discussed primarily herein with regards to dryblended powdered nutritional compositions and dry ingredients used therein, it should be noted that the processes for inactivating microbes of the present disclosure are equally applicable to non-dryblended powdered nutritional compositions (e.g., spray dried nutritional compositions) that are in need of microbial reduction. Such bioburden reduction can be achieved in any powdered nutritional composition when the powdered nutritional compositions are subjected to the times and temperatures of the numerous microbial inactivation processes of the present disclosure. As with the processes for inactivating the microbes in the dryblended powdered compositions and dry ingredients as described herein, the microbial load in the non-dryblended powdered nutritional can be reduced without significantly impacting the nutritional quality of the powdered nutritional.

### Product Form

The dryblended powdered nutritional compositions prepared by the methods of the present disclosure and described in detail herein include at least one dry ingredient dryblended into a base powder. These powders are typically in the form of flowable or substantially flowable particulate compositions, or at least particulate compositions that can be easily scooped and measured with a spoon or other similar device, wherein the compositions can easily be reconstituted by the intended user with a suitable aqueous liquid, typically water, to form a liquid nutritional composition for immediate oral or enteral use. In this context, “immediate” use generally means within about 48 hours, most typically within about 24 hours, preferably right after reconstitution.

The base powders for use in the dryblended nutritional powders including the at least one dry ingredient, can be spray dried powders, agglomerated powders, combinations thereof, or powders prepared by other suitable methods. In some embodiments, the base powders include 100% by weight dryblended or dry mixed ingredients.

The dryblended powdered nutritional compositions may be formulated with sufficient kinds and amounts of nutrients so as to provide a sole, primary, or supplemental source of nutrition, or to provide a specialized powdered nutritional composition for use in individuals afflicted with specific diseases or conditions.

Specific non-limiting examples of product forms prepared using the methods as disclosed herein include, for example, dryblended powdered human milk fortifiers, dryblended powdered preterm infant formulas, dryblended powdered infant formulas, dryblended powdered elemental and semi-elemental formulas, dryblended powdered pediatric formulas, dryblended powdered toddler formulas, dryblended powdered adult formulas, and dryblended powdered medicinal formulas.

The dryblended powdered nutritional compositions may have a caloric density tailored to the nutritional needs of the ultimate user, although in most instances the reconstituted powders comprise from about 100 to about 900 kcal/240 mL, including from about 150 to about 350 kcal/240 mL, and also including from about 200 to about 320 kcal/240 mL. Most common caloric densities for the infant formula embodiments of the present disclosure are generally at least 19 kcal/fl oz (660 kcal/liter), more typically from about 20 kcal/fl oz (675-680 kcal/liter) to about 25 kcal/fl oz (820 kcal/liter), even more typically from about 20 kcal/fl oz (675-680 kcal/liter) to about 24 kcal/fl oz (800-810 kcal/liter). Generally, the 22-24 kcal/fl oz formulas are more commonly used in pre-term or low birth weight infants, and the 20-21 kcal/fl oz (675-680 to 700 kcal/liter) formulas are more often used in term infants. Non-infant and adult nutritional powders may have any caloric density suitable for the targeted or intended population.

### Macronutrients

The dryblended powdered nutritional compositions include at least one of fat, protein, and carbohydrate, and in many embodiments, will include all three. Any one or more of these macronutrients can be in the form of a dry ingredient that can be treated for microbial contamination as described herein and then dryblended into a base powder to form the dryblended powdered nutritional compositions. Alternatively, the macronutrient can be dryblended into the base powder and the resulting dryblended powder treated for microbial contamination as described herein. In particularly suitable embodiments, the dry ingredients include one or more carbohydrates including, for example, rice starch and/or sucrose. In another embodiment, the dry ingredient includes one or more proteins, including, for example, milk protein isolate.

Generally, any source of fat, carbohydrate, and/or protein that is known or otherwise suitable for use in nutritional products may also be suitable for use herein, provided that such macronutrients are also compatible with the essential elements of the dryblended powdered nutritional compositions as defined herein.

Although total concentrations or amounts of the fat, protein, and carbohydrates may vary depending upon the nutritional needs of the intended user, such concentrations or amounts most typically fall within one of the following embodied ranges, inclusive of any other essential fat, protein, and/or carbohydrate ingredients as described herein.

Carbohydrate concentrations most typically range from about 5% to about 40%, including from about 5% to about 35%, including from about 5% to about 30%, including from about 7% to about 30%, including from about 10% to about 30%, including from about 10% to about 25%, by weight of the dryblended powdered nutritional composition; fat concentrations most typically range from about 0.5% to about 30%, from about 0.5% to about 25%, including from about 0.5% to about 20%, including from about 0.75% to about 20%, including from about 1% to about 15%, including from about 1% to about 10%, and also including from about 2% to about 5%, by weight of the dryblended powdered nutritional composition; and protein concentrations most typically range from about 5% to about 85%, including from about 5% to about 75%, including from about 5% to about 70%, including from about 5% to about 60%, including from about 7% to about 50%, and also including from about 8% to about 32%, by weight of the dryblended powdered nutritional composition. Additional ranges for carbohydrates, fats, and proteins, based on % calories of the drvhlended nowdered nutritional composition, are set forth in the following table.

| Nutrient (% Calories) | Embodiment A | Embodiment B | Embodiment C |
|---|---|---|---|
| Carbohydrate | 1-98 | 30-70 | 35-60 |
| Fat | 1-98 | 20-60 | 25-50 |
| Protein | 1-98 | 10-50 | 15-40 |

Non-limiting examples of suitable fats or sources thereof for use in the dryblended powdered nutritional compositions described herein include coconut oil, fractionated coconut oil, soy oil, corn oil, olive oil, safflower oil, high oleic safflower oil, MCT oil (medium chain triglycerides), sunflower oil, high oleic sunflower oil, DHA oil, ARA oil, palm and palm kernel oils, palm olein, canola oil, marine oils, cottonseed oils, and combinations thereof. Particularly suitable fats include high oleic safflower oil, soy oil, and coconut oil, all of which can be used individually or in any combination.

Non-limiting examples of suitable carbohydrates or sources thereof for use in the dryblended powdered nutritional compositions described herein may include maltodextrin, hydrolyzed or modified starch or cornstarch, glucose polymers, corn syrup, corn syrup solids, rice-derived carbohydrates, glucose, fructose, lactose, high fructose corn syrup, honey, sugar alcohols (e.g., maltitol, erythritol, sorbitol), and combinations thereof. Particularly suitable carbohydrates for use as the dry ingredient to be dryblended into a nutritional base powder include starches, lactose, and combinations thereof. One particularly suitable carbohydrate for use as the dry ingredient includes rice starch.

Non-limiting examples of suitable proteins or sources thereof for use in the dryblended powdered nutritional compositions include partially hydrolyzed (degree of hydrolysis less than 25%) or non-hydrolyzed proteins (i.e., intact) or protein sources, which may be derived from any known or otherwise suitable source such as milk (e.g., casein, whey), animal (e.g., meat, fish), cereal (e.g., rice, corn), or combinations thereof. Non-limiting examples of such proteins include milk protein isolates, milk protein concentrates as described herein, such as whey protein concentrates, casein protein isolates, whey protein, caseinates, whole cow's milk, partially or completely defatted milk, soy protein isolates, soy protein concentrates, and so forth. A particularly suitable protein source, that can optionally be dryblended into the dryblended composition, includes milk protein isolate.

### Optional Ingredients

The dryblended powdered nutritional compositions described herein may further comprise other optional ingredients that may modify the physical, chemical, hedonic or processing characteristics of the products or serve as pharmaceutical or additional nutritional components when used in the targeted population. Many such optional ingredients are known or otherwise suitable for use in other nutritional products and may also be used in the dryblended powdered nutritional compositions described herein, provided that such optional ingredients are safe and effective for oral administration and are compatible with the essential and other ingredients in the dryblended powdered nutritional compositions.

Non-limiting examples of such optional ingredients include preservatives, cocoa powder, lecithin, guar gum, xanthan gum, carrageenan, gellan gum, antioxidants, emulsifying agents, buffers, pharmaceutical actives, additional nutrients as described herein, colorants, flavors, thickening agents and stabilizers, and so forth.

The dryblended powdered nutritional compositions may further comprise vitamins or related nutrients, non-limiting examples of which include vitamin A, vitamin E, vitamin K, thiamine, riboflavin, pyridoxine, vitamin B12, carotenoids, niacin, folic acid, pantothenic acid, biotin, vitamin C, choline, inositol, salts, and derivatives thereof, and combinations thereof.

The dryblended powdered nutritional compositions may further comprise minerals, non-limiting examples of which include phosphorus, magnesium, iron, zinc, manganese, copper, sodium, potassium, molybdenum, chromium, selenium, chloride, and combinations thereof.

The dryblended powdered nutritional compositions may also include one or more masking agents to reduce or otherwise obscure bitter flavors and after taste in the reconstituted powders. Suitable masking agents include natural and artificial sweeteners, sodium sources such as sodium chloride, hydrocolloids and combinations thereof. The amount of masking agent in the dryblended powdered nutritional composition may vary depending upon the particular masking agent selected, other ingredients in the composition, and other composition or product target variables. Such amounts, however, most typically range from at least 0.1%, including from about 0.15% to about 3.0%, and also including from about 0.18% to about 2.5%, by weight of the dryblended powdered nutritional composition.

### EXAMPLES

The following examples illustrate specific embodiments and/or features of the dryblended powdered nutritional compositions prepared using the methods of the present disclosure. The examples are given solely for the purpose of illustration and are not to be construed as limitations of the present disclosure, as many variations thereof are possible without departing from the spirit and scope of the disclosure. All exemplified amounts are weight percentages based upon the total weight of the composition, unless otherwise specified.

The exemplified compositions are dryblended powdered nutritional compositions that may be prepared in accordance with the manufacturing methods described herein, such that each exemplified powdered nutritional composition has a reduced risk of microbial contamination.

### Examples 1-5

Examples 1-5 illustrate dryblended powdered infant formulas of the present disclosure, the ingredients of which are listed in the table below. All ingredient amounts are listed as kg per 1000 kg batch, unless otherwise specified.

To prepare the dryblended powdered infant formulas, the rice starch component was first subjected to a heat treatment at a temperature from about 50° C. to less than 60° C. for a period of from 2 days to about 10 days. Once treated, the rice starch was dryblended with the remaining ingredients that had been utilized to prepare a conventional base powder.

| Ingredient | Example 1 | Example 2 | Example 3 | Example 4 | Example 5 |
|---|---|---|---|---|---|
| Corn Syrup | 335.20 | 335.20 | 308.79 | 308.79 | 308.79 |
| Rice Starch (dryblended) | 165.12 | 183.62 | 163.88 | 163.88 | 200.89 |
| Milk Protein Isolate | 125.89 | 125.89 | 12571 | 12571 | 12571 |
| High Oleic Safflower Oil | 116.30 | 116.30 | 119.74 | 119.74 | 119.74 |
| Sucrose | 104.58 | 104.58 | 96.96 | 96.96 | 96.96 |
| Soy Oil | 82.30 | 82.30 | 84.71 | 84.71 | 84.71 |
| Coconut Oil | 81.20 | 81.20 | 83.59 | 83.59 | 83.59 |
| Galactooligosaccharides | 0.0 | 18.51 | 37.01 | 37.01 | 0.00 |
| Calcium Phosphate Tribasic | 9.82 | 9.82 | 9.80 | 9.80 | 9.80 |
| Potassium Citrate | 6.83 | 6.83 | 7.15 | 7.15 | 7.15 |
| Potassium Chloride | 4.91 | 4.91 | 4.86 | 4.86 | 4.86 |
| Potassium Phosphate Dibasic | 3.67 | 3.67 | 3.67 | 3.67 | 3.67 |
| Calcium Carbonate | 3.41 | 3.41 | 3.41 | 3.41 | 3.41 |
| ARA Oil | 2.96 | 2.96 | 3.11 | 3.11 | 3.11 |
| Magnesium Chloride | 2.88 | 2.88 | 2.85 | 2.85 | 2.85 |
| Nucleotide Premix | 2.62 | 2.62 | 2.62 | 2.62 | 2.62 |
| Ascorbic Acid | 1.59 | 1.59 | 1.59 | 1.59 | 1.59 |
| Water-soluble Vitamin Premix | 1.43 | 1.43 | 1.43 | 1.43 | 1.43 |
| DHA oil | 1.17 | 1.17 | 1.23 | 1.23 | 1.23 |
| L-cystine Dihydrochloride | 1.10 | 1.10 | 1.10 | 1.10 | 1.10 |
| Choline Chloride | 910.00 g | 910.00 g | 910.03 g | 910.03 g | 910.03 g |
| Ascorbyl Palmitate | 858.50 g | 858.50 g | 858.70 g | 858.70 g | 858.70 g |
| Sodium Chloride | 796.70 g | 796.70 g | 752.82 g | 752.82 g | 752.82 g |
| Ferrous Sulfate | 453.50 g | 453.50 g | 454.01 g | 454.01 g | 454.01 g |
| Vitamin ADEK Premix | 350.75 g | 350.75 g | 351.17 g | 351.17 g | 351.17 g |
| Mixed Carotenoids | 0.00 | 0.00 | 187.39 g | 187.39 g | 187.39 g |
| Mixed Tocopherols | 158.30 g | 158.30 g | 158.03 g | 158.03 g | 158.03 g |
| L-carnitine | 107.80 g | 107.80 g | 107.81 g | 107.81 g | 107.81 g |
| Beta-carotene | 11.95 g | 11.95 g | 0.00 | 0.00 | 0.00 |
| Vitamin A Palmitate | 8.06 g | 8.06 g | 8.07 g | 8.07 g | 8.07 g |
| Riboflavin | 5.40 g | 5.40 g | 5.40 g | 5.40 g | 5.40 g |
| Potassium Iodide | 1.01 g | 1.01 g | 1.47 g | 1.47 g | 1.47 g |
| Potassium Hydroxide | As needed | As needed | As needed | As needed | As needed |

### Example 6

In this Example, methods of the present disclosure were evaluated to determine effectiveness to inactivate bacterial cultures associated with a nutritional ingredient.

A mixture of heat and dry-stressed cultures of Cronobacter species, consisting of ATCC 295544 and ATCC 51329 strains, were inoculated into rice starch and stored at temperatures ranging from room temperature to 60° C. for up to 10 days. Inocula levels of 100 colony forming units/gram (cfu/g) to 1000 cfu/g were at a minimum used. The number of non-inactivated microbes were estimated using the Most Probable Number (MPN) method using ISO 22964, Milk and milk products—Detection of Enterobacter sakazakii, enrichment and post selective enrichment procedures. The results are shown in the tables below.

TABLE 1
MPN test results after 10 days of storage at 48° C.,
55° C., 60° C., and room temperature.

| | Room | | | |
|---|---|---|---|---|
| | Temperature | 48° C. | 55° C. | 60° C. |
| Number of | 10/10 | 0/10 | 0/10 | 0/10 |
| positive | | | | |
| results/10 test | | | | |
| tube | | | | |
| Sample weight | 100 g | 10 g | 100 g | 100 g |

TABLE 2
MPN test results and calculated log reduction of Cronobacter
species during 10-day storage at various temperatures.

| | Room Temperature | | | 48° C. | | | 60° C. | | |
|---|---|---|---|---|---|---|---|---|---|
| | 4 days | 7 days | 10 days | 4 days | 7 days | 10 days | 4 days | 7 days | 10 days |
| Number of positive | 10/10 | 10/10 | 10/10 | 0/10 | 3/10 | 2/10 | 0/10 | 0/10 | 0/10 |
| results/10 test tube | | | | | | | | | |
| Sample weight | 10 g | 10 g | 10 g | 10 g | 100 g | 100 g | 10 g | 100 g | 100 g |
| Log reduction | 0 | 0 | 0 | >4.0 | 4.50 | 4.70 | >4.0 | >5.0 | >5.0 |

TABLE 3
MPN test results and calculated log reduction of Cronobacter
species during 7-day storage at various temperatures.

| | Room Temperature | | 48° C. | | 50° C. | |
|---|---|---|---|---|---|---|
| | 4 days | 7 days | 4 days | 7 days | 4 days | 7 days |
| Number of positive | 10/10 | 10/10 | 8/10 | 5/10 | 3/10 | 1/10 |
| results/10 test | | | | | | |
| Sample weight | 10 g | 10 g | 10 g | 10 g | 10 g | 10 g |
| Log reduction | 0 | 0 | 4.80 | 5.20 | 5.44 | 5.95 |

As shown in the tables, by storing the nutritional ingredient including the inoculated bacteria at a temperature between 48° C. and 60° C. in accordance with the present disclosure, the bacteria was substantially inactivated. Particularly, when stored at 60° C., all bacteria were inactivated after just 4 days of storage.

1-15. (canceled)

16. A method of inactivating microbes in a dry ingredient, the method comprising subjecting the dry ingredient to at a temperature of greater than 48° C. to no greater than 60° C. for a period of from 2 days to 30 days, wherein at least 90% of microbes present in the dry ingredient are inactivated.

17. The method of claim 16 wherein the dry ingredient is a carbohydrate.

18. The method according to claim 16, wherein the dry ingredient is selected from the group consisting of carbohydrate, starch, xanthan gum, cocoa powder, lactose, maltodextrin, sucrose, lecithin, mineral salts, and combinations thereof.

19. The method according to claim 16, wherein the dry ingredient is rice starch.

20. The method according to claim 16, wherein the dry ingredient is a protein.

21. The method according to claim 16, wherein the dry ingredient is subjected to a heat treatment of 50° C. to 60° C.

22. The method according to claim 16, wherein the dry ingredient is subjected to a heat treatment of 55° C. to 60° C.

23. The method according to claim 16, wherein the dry ingredient is heated for a period of 2 days to 4 days.

24. The method according to claim 16, wherein at least 99% of microbes present in the dry ingredient are inactivated.

25. A method of preparing a dryblended powdered nutritional composition, the dryblended powdered nutritional composition comprising at least one dry ingredient, the method comprising subjecting the dry ingredient to a heat treatment at a temperature of greater than 48° C. to no greater than 60° C. for a period of from 2 days to 30 days and dryblending the heat treated dry ingredient with a base powder to form the dryblended powdered nutritional composition, wherein at least 90% of microbes present in the dryblended powdered nutritional composition are inactivated.

26. The method of claim 25, wherein the dry ingredient is a carbohydrate.

27. The method of claim 25, wherein the ingredient is selected from the group consisting of carbohydrate, starch, xanthan gum, cocoa powder, lactose, lecithin, and combinations thereof.

28. The method of claim 25, wherein the dry ingredient is rice starch.

29. The method of claim 25, wherein the dry ingredient is protein.

30. A method of preparing a powdered nutritional composition, the method comprising dryblending a dry ingredient with a base powder to form a dryblended powdered nutritional composition; and subjecting the dryblended powdered nutritional composition to a heat treatment at a temperature of greater than 48° C. to no greater than 60° C. for a period of from 2 days to 30 days, wherein at least 90% of microbes present in the dryblended powdered nutritional composition are inactivated.

31. The method of claim 30, wherein the dry ingredient is a carbohydrate.

32. The method of claim 30, wherein the dry ingredient is selected from the group consisting of carbohydrate, starch, xanthan gum, cocoa powder, lactose, lecithin, and combinations thereof.

33. The method of claim 30, wherein the dry ingredient is rice starch.

34. The method of claim 30, wherein at least 99% of microbes present in the dryblended powdered nutritional composition are inactivated.
